(19) United States
(12) Patent Application Publication
(10) Pub. No.: US 2025/0165299 A1
(43) Pub. Date: May 22, 2025

(54) APPLICATION DISTRIBUTION APPARATUS, APPLICATION DISTRIBUTION METHOD, AND STORAGE MEDIUM

(71) Applicant: NEC Corporation, Minato-ku, Tokyo (JP)

(72) Inventors: Hideki KIKKAWA, Tokyo (JP); Hideki MURAMATSU, Tokyo (JP); Junya KAWAI, Tokyo (JP); Kosei KOBAYASHI, Tokyo (JP); Masayuki TAKEKAWA, Tokyo (JP)

(73) Assignee: NEC Corporation, Minato-ku, Tokyo (JP)

(21) Appl. No.: 18/840,119

(22) PCT Filed: Mar. 29, 2022
(86) PCT No.: PCT/JP2022/015434

§ 371 Date: Aug. 21, 2024

(51) Int. Cl. G06F 9/50

(52) U.S. Cl. CPC G06F 9/5038

(57) ABSTRACT

In order to make it possible to more easily share a plurality of servers each of which can be a distribution destination of an application, an application distribution apparatus (10) includes: a management unit (11) that manages, for each of a plurality of servers, a location and a use condition of the server; an acquisition unit (12) that acquires a distribution request for an application, the distribution request including information pertaining to a desired execution area; a selection unit (13) that selects, as candidate servers, servers included in the desired execution area from among the plurality of servers; a determination unit (14) that determines one or more distribution destination servers that satisfy the use condition from among the candidate servers; and a distribution unit (15) that distributes the application to the one or more distribution destination servers.

### TECHNICAL FIELD

The present invention relates to a technique for distributing an application to a server.

### BACKGROUND ART

A technology for distributing an application to one of a plurality of servers has been known. Patent Literature 1 discloses a technique for selecting, on the basis of an amount of delay between a server and a plurality of client terminals, a server in a location as a distribution destination of an application from among servers that are disposed in a plurality of locations in a network.

### CITATION LIST

### Patent Literature

### [Patent Literature 1]

International Publication No. WO 2021/171521

### SUMMARY OF INVENTION

### Technical Problem

It is conceivable to share, between a plurality of organizations and/or the like, a plurality of servers each of which can be a distribution destination of an application. For example, any organization can provide a service to a terminal with use of any one of servers by distributing a desired application to the server. This makes it possible to efficiently use the plurality of servers. However, in the technique disclosed in Patent Literature 1, one server is selected from the viewpoint of the amount of delay. Thus, the server selected may not necessarily be suitable for execution of a desired application. On this account, the technique had a problem that sharing a plurality of servers each of which can be a distribution destination of an application was difficult.

An example aspect of the present invention is attained in view of the above problem, and an example object of an aspect of the present invention is to provide a technique for making it possible to more easily share a plurality of servers each of which can be a distribution destination of an application.

### Solution to Problem

An application distribution apparatus according to an aspect of the present invention includes: a management means that manages, for each of a plurality of servers, a location and a use condition of the server; an acquisition means that acquires a distribution request for an application, the distribution request including information pertaining to a desired execution area; a selection means that selects, as candidate servers, servers included in the desired execution area from among the plurality of servers; a determination means that determines one or more distribution destination servers that satisfy the use condition from among the candidate servers; and a distribution means that distributes the application to the one or more distribution destination servers.

An application distribution method according to an aspect of the present invention includes: managing, for each of a plurality of servers, a location and a use condition of the server; acquiring a distribution request for an application, the distribution request including information pertaining to a desired execution area; selecting, as candidate servers, servers included in the desired execution area from among the plurality of servers; determining one or more distribution destination servers that satisfy the use condition from among the candidate servers; and distributing the application to the one or more distribution destination servers.

A program according to an aspect of the present invention for causing a computer to function as an application distribution apparatus, the program causing the computer to function as: management means that manages, for each of a plurality of servers, a location and a use condition of the server; an acquisition means that acquires a distribution request for an application, the distribution request including information pertaining to a desired execution area; a selection means that selects, as candidate servers, servers included in the desired execution area from among the plurality of servers;

a determination means that determines one or more distribution destination servers that satisfy the use condition from among the candidate servers; and a distribution means that distributes the application to the one or more distribution destination servers.

### Advantageous Effects of Invention

An example aspect of the present invention can make it possible to more easily share a plurality of servers each of which can be a distribution destination of an application.

### BRIEF DESCRIPTION OF DRAWINGS

FIG. 1 is a block diagram illustrating a configuration of an application distribution apparatus according to a first example embodiment of the present invention.

FIG. 2 is a flow chart showing a flow of an application distribution method according to the first example embodiment of the present invention.

FIG. 3 is a block diagram illustrating a configuration of an application distribution system according to the second example embodiment of the present invention.

FIG. 4 is a block diagram illustrating a configuration of an application distribution apparatus according to the second example embodiment of the present invention.

FIG. 5 is a diagram showing a specific example of server information according to the second example embodiment of the present invention.

FIG. 6 is a flow chart showing a flow of an application distribution method according to the second example embodiment of the present invention.

FIG. 7 is a diagram showing a specific example of a distribution request according to the second example embodiment of the present invention.

FIG. 8 is a flow chart showing a detailed flow of a changing process shown in FIG. 6.

FIG. 9 is a diagram showing a specific example of notification information that is displayed by a terminal in the second example embodiment of the present invention.

FIG. 10 is a block diagram illustrating a hardware configuration example of the application distribution apparatus according to each example embodiment of the present invention.

### DESCRIPTION OF EMBODIMENTS

### First Example Embodiment

The following description will discuss in detail a first example embodiment of the present invention, with reference to drawings. The present example embodiment is a basic form of example embodiments described later.

### <Configuration of Application Distribution Apparatus 10>

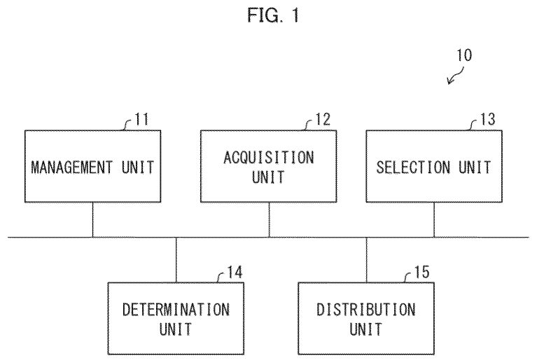

The following will discuss a configuration of an application distribution apparatus 10 in accordance with the present example embodiment, with reference to FIG. 1. FIG. 1 is a block diagram illustrating a configuration of the application distribution apparatus 10. As illustrated in FIG. 1, the application distribution apparatus 10 includes a management unit 11, an acquisition unit 12, a selection unit 13, a determination unit 14, and a distribution unit 15.

The management unit 11 manages, for each of a plurality of servers, a location and a use condition of the server. The acquisition unit 12 acquires a distribution request for an application, which is a distribution request including information pertaining to a desired execution area. The selection unit 13 candidate servers, servers included in the desired execution area from among the plurality of servers. The determination unit 14 determines one or more distribution destination servers that satisfy the use condition from among the candidate servers. The distribution unit 15 distributes the application to the one or more distribution destination servers. Details of each of these functional blocks will be described later in the section “Flow of application distribution method S1”.

Note that the above-described application includes, for example, software in general and firmware in general, and refers to all non-hardware processing subjects.

### <Flow of Application Distribution Method S1>

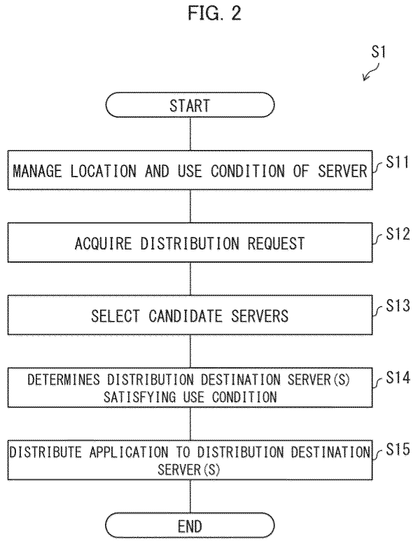

The following will discuss a flow of an application distribution method S1 in accordance with the present example embodiment, with reference to FIG. 2. FIG. 2 is a flow chart showing a flow of the application distribution method S1. As illustrated in FIG. 2, the application distribution method S1 includes steps S11 to S15.

### (Step S11)

In step S11, the management unit 11 manages, for each of a plurality of servers, a location and a use condition of the server. For example, the management unit 11 may manage respective pieces of information indicating each server, a location thereof, and a use condition thereof by associating the pieces of information with each other and store the pieces of information. Here, the use condition is a condition for using the server as a server for executing an application. For example, the use condition may be a condition corresponding to characteristics, a state, an operation policy, or the like of each server. However, the use condition is not limited to the above-described examples.

### (Step S12)

In step S12, the acquisition unit 12 acquires a distribution request for an application, which is a distribution request including information pertaining to a desired execution area. Here, the desired execution area refers to an area that is desired as a location of a server that executes the application. For example, an area which is physically close to a terminal that will use the application that is to be distributed can be specified as the desired execution area.

### (Step S13)

In step S13, the selection unit 13 selects, as candidate servers, servers that are included in the desired execution area from among the plurality of servers. The servers that are included in the desired execution area are each a server whose location managed by the management unit 11 is included in the desired execution area.

### (Step S14)

In step S14, the determination unit 14 determines one or more distribution destination servers that satisfy the use condition from among the candidate servers. For example, when there are a plurality of servers that satisfy the use condition, the determination unit 14 may determine all of the servers as the distribution destination servers or may determine one or some of the servers as the distribution destination servers.

### (Step S15)

In step S15, the distribution unit 15 distributes the application to the one or more distribution destination servers. For example, the distribution unit 15 may distribute, to the one or more distribution destination servers, the application that is indicated by the distribution request and that is stored in advance in the application distribution apparatus 10. Further, for example, the distribution unit 15 may externally obtain the application indicated by the distribution request, and distribute, to the one or more distribution destination servers, the application obtained. Further, the distribution unit 15 may control an external apparatus that stores the application indicated by the distribution request, so as to cause the application to be distributed to the one or more distribution destination servers from the external apparatus.

### <Implementation Example By Program>

In a case where the application distribution apparatus 10 is configured by a computer, the following program is stored in a memory that is to be referred to by the computer. The program is a program for causing a computer to function as the application distribution apparatus 10, the program causing the computer to function as: the management unit 11 that manages, for each of a plurality of servers, a location and a use condition of the server; the acquisition unit 12 that acquires a distribution request for an application, the distribution request including information pertaining to a desired execution area; a selection unit 13 that selects, as candidate servers, servers included in the desired execution area from among the plurality of servers; a determination unit 14 that determines one or more distribution destination servers that satisfy the use condition among the candidate servers; and a distribution unit 15 for distributing the application to the one or more distribution destination servers.

The above-described application distribution apparatus 10 and the above-described application distribution method S1 are realized by the computer executing the program.

### <Example Advantage of Present Example Embodiment>

As described above, the present example embodiment employs a configuration in which: for each of a plurality of servers, a location and a use condition of the server are managed; a distribution request for an application is acquired, the distribution request including information pertaining to a desired execution area; servers included in the desired execution area are selected, as candidate servers, from among the plurality of servers; one or more distribution destination servers that satisfy the use condition are determined from among the candidate servers; and the application is distributed to the one or more distribution destination servers.

For this reason, according to the present example embodiment, an application to be executed is distributed to each server in a case where the server satisfies the use condition. However, in a case where the server does not satisfy the use condition, the application is not distributed to the server. Therefore, the use condition can be set in accordance with each server, and the server can be more easily shared. As a result, an example advantage of making it possible to more easily share a plurality of servers each of which can be a distribution destination of an application can be obtained.

### Second Example Embodiment

The following description will discuss in detail a second example embodiment of the present invention, with reference to drawings. Note that components having the same functions as those described in the first example embodiment are denoted by the same reference numerals, and descriptions thereof will be omitted as appropriate.

### <Configuration of Application Distribution System 1A>

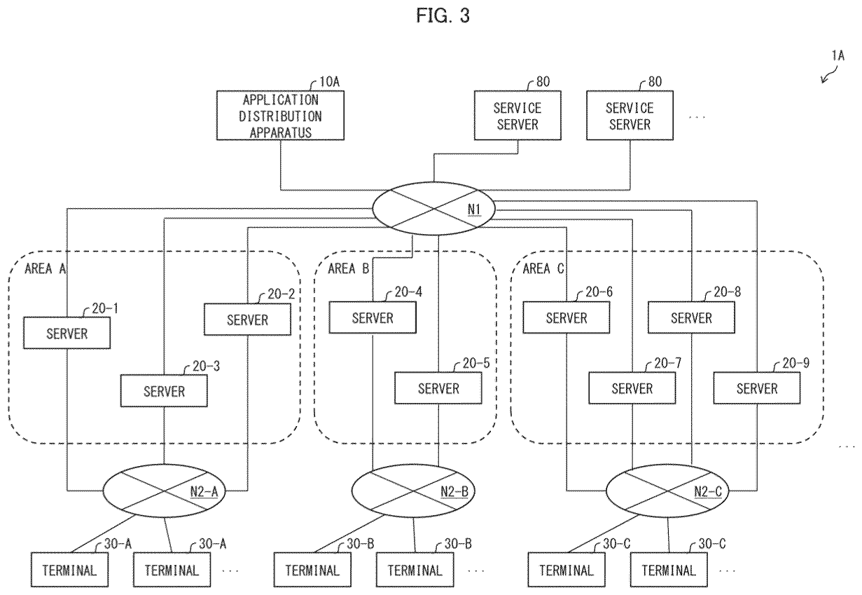

The following will discuss a configuration of an application distribution system 1A in accordance with the present example embodiment, with reference to FIG. 3. FIG. 3 is a block diagram illustrating a configuration of the application distribution system 1A. As illustrated in FIG. 3, the application distribution system 1A includes an application distribution apparatus 10A, servers 20-1, 20-2, . . . , 20-9, . . . , terminals 30-A, 30-B, 30-C, . . . , and service servers 80. When it is not necessary to particularly distinguish each of the servers 20-1, 20-2, . . . , the servers 20-1, 20-2, . . . , are referred to simply as the server(s) 20. When it is not necessary to particularly distinguish each of the terminals 30-A, 30-B, 30-C, . . . , the terminals 30-A, 30-B, 30-C, . . . , are referred to simply as the terminal(s) 30.

The application distribution apparatus 10A is connected to the servers 20 and the service servers 80 via the network N1 so as to be capable of communicating with the server 20 and the service servers 80.

The service servers 80 are connected to the servers 20 via the network N1. The network N1 may be configured to include, for example, a WAN such as the Internet, but is not limited to such a configuration. The service servers 80 each may be, but are not limited to, a server that is called a cloud server.

The servers 20 are connected to the terminals 30 via networks N2-A, N2-B, N2-C, . . . . Hereinafter, in a case where it is not necessary to particularly distinguish each of the networks N2-A, N2-B, and N2-C, the networks N2-A, N2-B, and N2-C are referred to simply as the network(s) N2. The networks N2 each may be configured to include, for example, mobile data communication, a radio local area network (LAN), or a wired LAN. As an example, the network N2 may include a wireless communication network of a fifth generation mobile communication system (5G) having low latency. However, the network N2 is not limited to the above-described examples. Further, the server 20 may be a server called an edge server, but the present invention is not limited thereto.

### (Service Server 80)

The service servers 80 are each a computer that carries out a process in cooperation with an application that is distributed to the server 20. The service server 80 provides a service by carrying out a process in cooperation with the application. Although two service servers 80 are illustrated in FIG. 3, the number of service servers 80 may be one or three or more. When a plurality of service servers 80 are included, each of the service servers 80 may provide the same service as at least one other service server 80 or may provide a different service. A provider that provides each service may be the same as or different from at least one other service server 80.

### (Server 20)

The server 20 is a computer that executes the application distributed. By executing the application distributed, the server 20 provides, in cooperation with the service server 80, a service to one or more terminals 30 that are physically close to the server 20.

For example, the location of the server 20 is included in one of areas A, B, C, . . . . Hereinafter, when it is not necessary to particularly distinguish each of the areas A, B, C, the areas A, B, C are referred to simply as an area(s). For example, the area is defined as a geographic region. The server 20 included in each area can be connected, via the network N2 corresponding to that area, to the terminal(s) 30 that is/are physically close to the server 20.

Specifically, in the example of FIG. 3, the servers 20-1, 20-2, and 20-3 are included in the area A. The network N2-A corresponds to the area A. Each of these servers 20 communicates, via the network N2-A, with the terminal(s) 30-A that is physically close. Further, the servers 20-4 and 20-5 are included in the area B. The network N2-B corresponds to the area B. Each of these servers 20 communicates, via the network N2-B, with the terminal(s) 30-B that is physically close. Further, the servers 20-6, 20-7, 20-8, and 20-9 are included in the area C. The network N2-C corresponds to the area C. Each of these servers 20 communicates, via the network N2-C, with the terminal(s) 30-C that is physically close. Note that the networks N2-A, N2-B, N2-C, . . . need not necessarily be each a separate network corresponding to an area. Some or all of these networks may constitute one network.

Note that, in FIG. 3, two terminals 30A, two terminals 30-B, and two terminals 30-C are illustrated. However, the number of the terminals 30 which are connected to each of the networks N2-A, N2-B and N2-C may be 1 or 3 or more.

### (Specific Examples of Service)

The following will discuss a service provided by execution of an application. Hereinafter, a service provided by execution of an application is also referred to as “service by application”.

For example, the service by an application may be a service in which real-time performance with respect to the terminal 30 is emphasized. Specific examples of such a service in which real-time performance is emphasized include a virtual reality service in which a user of the terminal 30 can experience a virtual reality. Further, as another example, there is a remote control service that remotely controls the terminal 30. Furthermore, as still another example, there is an image analysis service in which an image received from the terminal 30 is analyzed in real time. In addition, as still another example, there is an information collection and distribution service that selectively distributes information collected in real time from the terminal 30. However, the service by an application is not limited to these.

The service by an application may also be a service provided in a specific period of time. Specific examples of such a specific period include, but are not limited to, a predetermined period after the occurrence of a disaster, an event holding period, and the like.

Note that such an application may be stored, at least in advance of distribution, in the service server 80 or in the application distribution apparatus 10A. Alternatively, the application may be stored, at least in advance of distribution, in another storage apparatus that is connected to the network N1 or N2.

### (Terminal 30)

The terminal 30 is a computer to which the service by an application is provided. For example, in the case of a virtual reality service, the terminal 30 is, for example, a virtual reality device. Further, for example, in the case of a remote control service, the terminal 30 is, for example, a control apparatus mounted on a construction machine, an automated guided vehicle, or the like. Further, for example, in the case of an image analysis service, the terminal 30 is, for example, a stationary computer connected to a monitoring camera. Further, for example, in the case of an information collection and distribution service, the terminal 30 is, for example, a smartphone, a tablet, or a personal computer. However, the terminal 30 is not limited to the above-described examples.

Further, for example, an input apparatus and/or a display apparatus may be connected to or incorporated in the terminal 30. In this case, the terminal 30 displays, on the display apparatus, information that has been received from the server 20. The terminal 30 also transmits, to the server 20, information that has been inputted from the input apparatus.

### (Application Distribution Apparatus 10A)

The application distribution apparatus 10A is an apparatus that not only receives a distribution request for an application but also distributes, to any of the servers 20, the application indicated by the distribution request. The number of the servers 20 each serving as a distribution destination may be one or more.

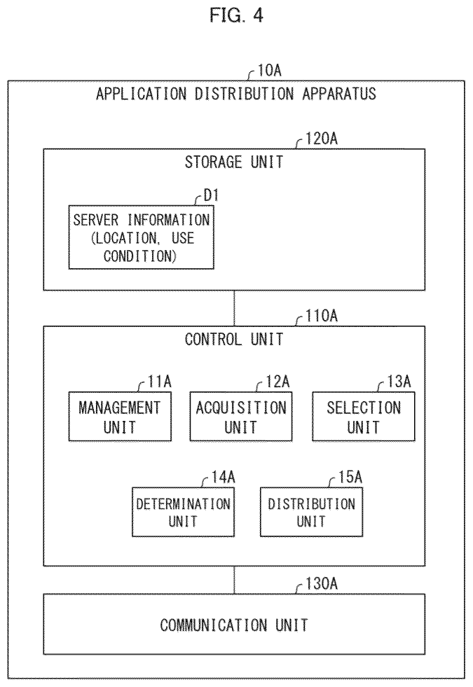

The following will discuss a configuration of the application distribution apparatus 10A, with reference to FIG. 4. FIG. 4 is a block diagram illustrating a configuration of the application distribution apparatus 10A. As illustrated in FIG. 4, the application distribution apparatus 10A includes a control unit 110A, a storage unit 120A, and a communication unit 130A. The control unit 110A carries out overall control of units of the application distribution apparatus 10A. The storage unit 120A stores various data to be used by the control unit 110A. The communication unit 130A transmits and receives data to and from another apparatus(es) under the control of the control unit 110A.

The control unit 110A includes a management unit 11A, an acquisition unit 12A, a selection unit 13A, a determination unit 14A, and a distribution unit 15A. The management unit 11A, the acquisition unit 12A, the selection unit 13A, and the determination unit 14A are configured in the same manner as respective functional blocks having same names in the first example embodiment. The distribution unit 15A is configured in substantially in the same manner as a block having the same name in each period in the first example embodiment. In addition, the distribution unit 15A is configured to carry out a changing process for changing a distribution status of an application, for a first distribution destination server that no longer satisfies a use condition among one or more distribution destination servers to which the application was distributed. Details of the changing process will be described later in the section “Flow of application distribution method S1A”.

The storage unit 120A stores therein server information D1. The server information D1 includes an example of information indicating a use condition and a location that are recited in Claims.

### (Server Information D1)

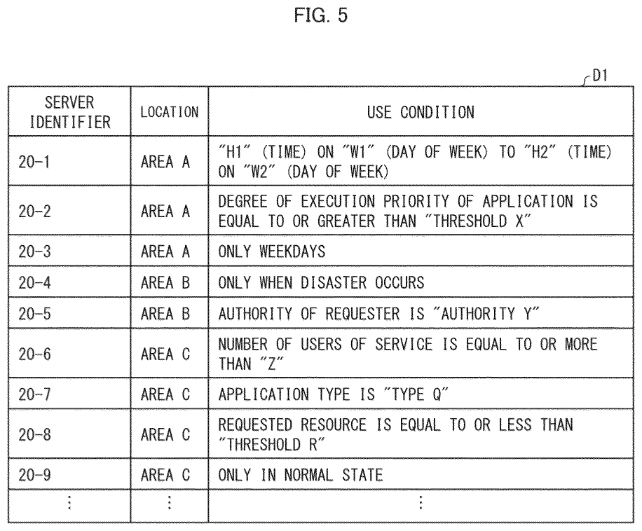

A specific example of the server information D1 will be described with reference to FIG. 5. FIG. 5 is a diagram showing a specific example of the server information D1. As illustrated in FIG. 5, the server information D1 includes information in which a server identifier, a location, and a use condition are associated with each other. In this example, respective identifiers of the servers 20-1, . . . are described as “20-1” etc.

### (Specific Examples of Location)

As illustrated in FIG. 5, the server identifiers 20-1, 20-2, and 20-3 are each associated with “area A” as the location. This indicates that respective locations of the servers 20-1, 20-2, and 20-3 are included in the area A. Further, the server identifiers 20-4 and 20-5 are each associated with “area B” as the location. This indicates that respective locations of the servers 20-4 and 20-5 are included in the area B. Further, the server identifiers 20-6 to 20-9 are each associated with “area C” as the location. This indicates that the respective locations of the servers 20-6, 20-7, 20-8, and 20-9 are included in the area C.

### (Specific Example 1 of use Condition)

For example, the use condition includes a condition related to time for executing an application. In FIG. 5, use conditions associated with the server identifiers 20-1 and 20-3 are examples of the condition related to time for executing an application. For example, these servers 20 are considered to be in a state in which an application that differs from the application which can be distributed to the servers 20 is being executed, and a load is varying. In such a case, a time period of a day in which the load is relatively low can be set in accordance with the state of the load being applied to each server 20.

For example, for the server 20-1, the use condition is set such that the application can be executed from “H1” (the time) on “W1” (day of the week) to “H2” (the time) on “W2” (day of the week). “W1” and “W2” refer to a predetermined day of the week. “H1” and “H2” refers to a predetermined time. On the other hand, for the server 20-3, the use condition is set such that the application can be executed only on weekdays.

The condition related to time is not limited to the example described above, but can be another time-related condition, such as a specific time period of a day, a specific date, and a specific period.

### (Specific Example 2 of use Condition)

Further, for example, the use condition includes a condition related to an application. In FIG. 5, use conditions associated with the server identifiers 20-2, 20-7, and 20-8 are examples of the condition related to an application.

For example, for the server 20-2, it is assumed that there is an operation policy according to which an application having a higher degree of execution priority is to be executed. In this case, the following use condition is set: an application can be executed if the degree of execution priority of the application is equal to or greater than a “threshold X”. The “threshold X” is a value included in a possible range for the degree of execution priority.

Further, for example, it is assumed that the server 20-7 has characteristics (e.g., processor performance, memory capacity, and the like) which are suitable for execution of an application of type “Q”. In this case, the use condition is set, according to the characteristics, such that an application can be executed if the application is of “type Q”. Note that “type Q” indicates a type into which an application can be classified. Examples of the application type include, but are not limited to, “virtual reality”, “remote control”, “video analysis”, and the like.

Further, for example, for the server 20-8, it is assumed that a retained resource that can be provided for execution of an application which can be distributed is limited to equal to or less than a “threshold R”. In this case, the use condition is set in accordance with limitation of the retained resource such that the application can be executed if a requested resource is equal to or less than the “threshold R”. Examples of the resource include, but are not limited to, a free memory capacity and processor performance. Note that the condition related to the requested resource is not necessarily limited to a condition of being equal to or less than a threshold value, but may be a condition of being equal to or more than a threshold value. In addition, the condition related to the requested resource is not limited to a condition represented by a numerical value. For example, the condition related to the requested resource may be a condition related to a type of an operating system, or the like.

Note that the condition related to an application is not limited to the examples described above, but may be another condition related to an application.

### (Specific Example 3 of use Condition)

Further, for example, the use condition includes a condition related to urgency. In FIG. 5, use conditions associated with the server identifiers 20-4 and 20-9 are examples of conditions each related to urgency.

For example, it is assumed that the server 20-4 has an operation policy according to which an application can be executed only in a case where a disaster occurs. In this case, the use condition is set, according to the operation policy, such that the application can be executed only in a case where a disaster occurs.

In addition, it is assumed that the server 20-9 does not have characteristics which can deal with access expected at the time when a disaster occurs. In this case, the use condition is set, according to the characteristics, such that an application can be executed only in a normal state.

Note that the condition related to urgency may be, for example, a condition which is expressed as a degree of urgency such that a level of the degree of urgency is equal to or more than a threshold value, equal to or less than a threshold value, or the like. However, the condition related to urgency is not limited to the above-described examples.

### (Specific Example 4 of use Condition)

Further, for example, the use condition includes a condition related to a requester of a distribution request. In FIG. 5, the use condition associated with the server identifier 20-5 is an example of a condition related to a requester of a distribution request. The requester of a distribution request is, for example, a provider that provides a service by an application. The provider may be, for example, an organization, a business operator, an individual, or the like, but is not limited thereto.

For example, it is assumed that the server 20-5 has an operation policy according to which an application is executed in a case where the requester has a predetermined authority “authority Y”. In this case, the use condition is set, according to the operation policy, such that the application can be executed only in a case where authority of the requester is “authority Y”. The “authority Y” refers to a type of authority that a requester may hold.

### (Specific Example 5 of use Condition)

Further, for example, the use condition includes a condition related to a user(s) of a service that is provided by an application. In FIG. 5, the use condition associated with the server identifier 20-6 is an example of a condition related to a user(s) of a service by an application.

For example, it is assumed that the server 20-6 has an operation policy according to which an application can be executed if the application is an application that provides a service to many users. In this case, the use condition is set, according to the operation policy, such that the application can be executed if the number of users of the service is equal to or more than “Z”.

The condition related to a user(s) of a service by an application is not limited to the number of users. The condition may be, for example, an attribute (gender, age) or the like that the user is assumed to have, but is not limited thereto.

### <Flow of Application Distribution Method S1A>

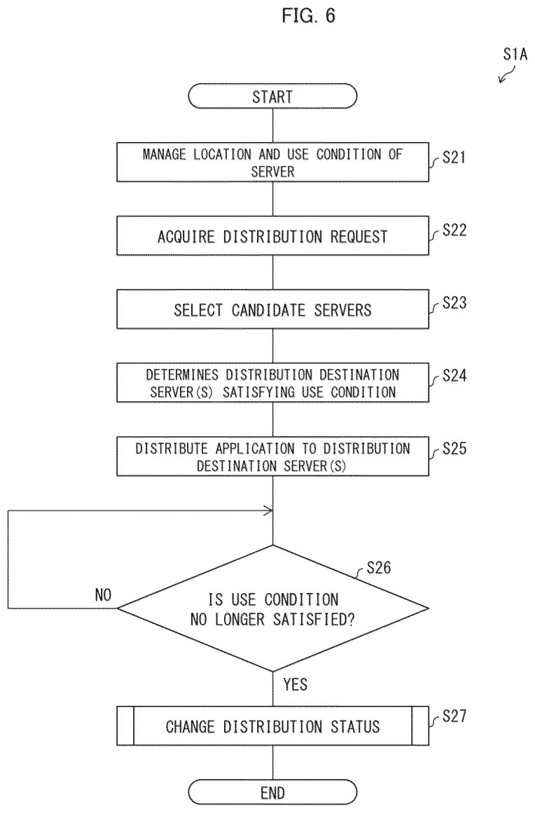

The application distribution apparatus 10A configured as described above executes the application distribution method S1A according to the present example embodiment. The following will discuss a flow of the application distribution method S1A with reference to FIG. 6. FIG. 6 is a flow chart showing a flow of the application distribution method S1A. As illustrated in FIG. 6, the application distribution method S1A includes steps S21 to S27.

### (Step S21)

In step S21, the management unit 11A manages, for each of a plurality of servers 20, a location and a use condition of the server 20. Specifically, the management unit 11A manages the server information D1 that is stored in the storage unit 120A. For example, the management unit 11A executes addition, change, deletion, or the like to the server information D1 and updates the server information D1, on the basis of information acquired from an external source.

### (Step S22)

In step S22, the acquisition unit 12A acquires a distribution request for an application, which is a distribution request including information pertaining to a desired execution area. For example, the acquisition unit 12A acquires a distribution request that is inputted by a provider of a service by the application. The provider may input such a distribution request through an input apparatus (not shown) that is connected to the application distribution apparatus 10A. The provider may also input such a distribution request with use of a terminal (not shown) that is connected to the application distribution apparatus 10A via the network N1.

### (Specific Example of Distribution Request)

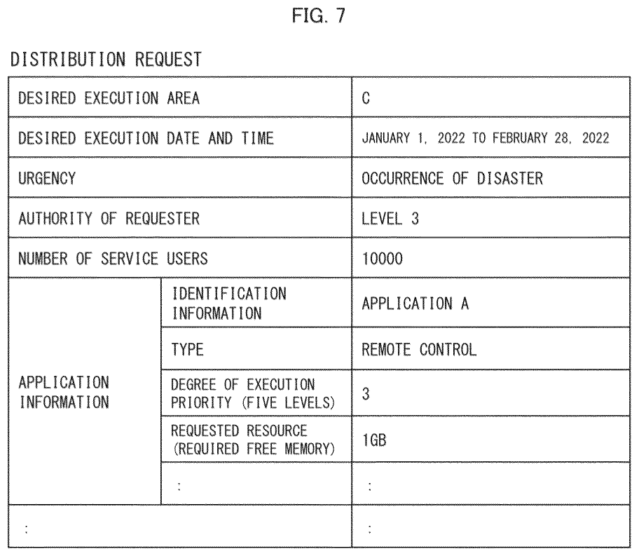

A specific example of the distribution request will now be described with reference to FIG. 7. FIG. 7 is a diagram showing a specific example of a distribution request. In FIG. 7, the distribution request includes a desired execution area, a desired execution date and time, urgency, authority of a requester, the number of service users, and application information.

The desired execution area refers to an area that is desired as a location of a server 20 that to execute the application. In this example, “C” (i.e., area C) is set as the desired execution area. The desired execution area is not limited to one area, and may include a plurality of areas.

Further, the desired execution date and time indicates time at which execution of the application is desired. In this example, a period of time “Jan. 1, 2022 to Feb. 28, 2022” is set as the desired execution date and time. The desired execution date may be a specific day of the week, time period of a day, date, time period, or the like other than a period of time.

Further, the urgency indicates urgency for executing of the application. For example, as the urgency, either “occurrence of disaster” (high urgency) or “normal” (low urgency) can be set. In this example, “occurrence of disaster” is set as the urgency.

Furthermore, the authority of a requester indicates authority granted to the requester. As described above, the requester of the distribution request is, for example, a provider of a service by the application. For example, it is assumed that the requester can be granted authority of any of levels 1 to 3. In this example, “level 3” is set for the authority of the requester.

In addition, the number of service users indicates the number of users who are expected to use the service by the application. In this example, “10000” users are set as the number of service users.

Further, the application information includes information pertaining to an application of which distribution is desired, and in this example, the application information includes identification information, a type, a degree of execution priority, and a requested resource.

The identification information of the application is information for identifying the application to be distributed. For example, in a case where there are a plurality of applications that can be distributed (for example, applications A to C), the identification information may be information for identifying one of the applications. In this example, “application A” is set as the identification information.

Further, the application type may be, for example, “virtual reality”, “remote control”, “video analysis”, or the like, but the type is not limited thereto. In this example, “remote control” is set as the application type.

The degree of execution priority of an application is, in this example, an integer of 1 to 5, and a larger number indicates a higher degree of priority. In this example, “3” is set as the degree of execution priority.

The requested resource of the application indicates, in this example, an amount of required free memory. In this case, the requested resource is set to 1 GB. However, the requested resource is not limited to the amount of required free memory, but may be any other requested resource.

### (Step S23)

In step S23 of FIG. 6, the selection unit 13A selects, as candidate servers, servers 20 that are included in the desired execution area from among the plurality of servers 20. For example, in the example of FIG. 7, since the desired execution area included in the distribution request is “area C”, the selection unit 13A selects the servers 20-6, 20-7, 20-8, and 20-9 included in the area C as the candidate servers.

### (Step S24)

In step S24, the determination unit 14A determines one or more distribution destination servers 20 that satisfy the use condition from among the candidate servers.

For example, the determination unit 14A refers to the server information D1 and determines whether or not the distribution request satisfies the use condition of the candidate servers (servers 20-6, 20-7, 20-8, and 20-9). For example, in the examples of FIGS. 5 and 7, the determination unit 14A determines that the “number of service users=10000” included in the distribution request satisfies the use condition ‘the number of service users is equal to or more than “Z”’ of the server 20-6 (e.g., in the case of Z=5000). Further, the determination unit 14A determines that the “application type=remote control” included in the distribution request satisfies the use condition ‘the application type is “type Q”’ of the server 20-7 (e.g., in the case of Q=remote control). In addition, the determination unit 14A determines that the “requested resource =1 GB” included in the distribution request satisfies the use condition ‘the requested resource is equal to or less than the “threshold R”’ of the server 20-8 (e.g., in the case of R=5 GB). Further, the determination unit 14A determines that “urgency=occurrence of disaster” included in the distribution request does not satisfy the use condition “only in normal state” of the server 20-9.

Therefore, the determination unit 14A determines distribution destination servers (servers 20-6, 20-7, and 20-8) from among the candidate servers (servers 20-6, 20-7, 20-8, and 20-9).

### (Step S25)

In step S25, the distribution unit 15A distributes the application to the one or more distribution destination servers. Here, the application distribution apparatus 10A can distribute the application based on the identification information of the application.

For example, in the example of FIG. 7, the identification information of the application included in the distribution request is “application A”. For example, it is assumed that an entity of the “application A” that can be distributed is stored in the storage unit 120A. In this case, the distribution unit 15A transmits the entity of the “application A” stored in the storage unit 120A to the distribution destination servers (servers 20-6, 20-7, and 20-8).

Further, for example, it is assumed that the distribution unit 15A can identify, on the basis of the identification information of the application, a storage location of the application on the network. For example, the distribution request may include a storage location of the application on the network in place of or in addition to the application identification information. In this case, the distribution unit 15A acquires the entity of the “application A” from the storage location and transmits the entity to the distribution destination servers (servers 20-6, 20-7, and 20-8).

Further, for example, it is assumed that the distribution unit 15A can identify a distribution apparatus that distributes the application, on the basis of the identification information of the application. For example, the distribution request may include information that specifies a distribution apparatus that distributes the application, in addition to the identification information of the application. In this case, the distribution unit 15A gives, to the distribution apparatus, a notification to distribute the entity of the “application A” to the distribution destination servers (servers 20-6, 20-7, and 20-8) from the distribution apparatus.

On completion of such distribution, the distribution unit 15A transmits a distribution result which reports that the application has been distributed to the distribution destination servers (servers 20-6, 20-7, and 20-8). For example, the distribution unit 15A may transmit the distribution result to the terminal through which the requester inputted the distribution request, or may transmit the distribution result to the service server 80.

Thus, the service server 80 provides the service to the terminal 30 in cooperation with the application that has been distributed to the distribution destination server.

### (Step S26)

In step S26, the distribution unit 15A determines whether or not the distribution destination server no longer satisfies the use condition. Specifically, the distribution unit 15A may periodically determine whether or not each of the one or more distribution destination servers satisfies the use condition.

For example, the distribution destination server that satisfied the use condition related to time may no longer satisfy the use condition with a lapse of time. For example, in a case where the distribution destination server satisfied a condition that specifies only weekdays, the condition is no longer satisfied at the weekend.

Further, for example, the distribution destination server that satisfied the use condition related to the urgency may no longer satisfy the use condition when the urgency changes. In this case, the application distribution apparatus 10A is configured to be able to acquire information pertaining to the latest urgency. For example, in a case where the distribution destination server satisfied a condition that specify only a case where a disaster occurs, the urgency becomes lower and the condition may no longer be satisfied after a predetermined period of time has elapsed from the occurrence of the disaster.

Further, for example, the distribution destination server that satisfied the use condition related to the user(s) of the service may no longer satisfy that condition due to a change of the users of the service. In this case, the application distribution apparatus 10A is configured to be able to acquire the latest information pertaining to the user(s) of the service. For example, in a case where the number of users of the service satisfied the condition of being equal to or more than the threshold, the condition may no longer be satisfied when the number of users of the service decreases.

Note that specific examples of cases where the use condition is no longer satisfied are not limited to the above-described examples. In the following description, among the one or more distribution destination servers, the distribution destination server that no longer satisfies the use condition is referred to as “first distribution destination server”.

For example, in the examples of FIGS. 5 and 7, it is assumed that the total number of terminals 30-C that are connected to the distribution destination servers (servers 20-6, 20-7, and 20-8) has decreased in the number of users from 10000, which was included in the distribution request, to 4000. In this case, the determination unit 14A determines that “the present number of service users=4000” no longer satisfies the use condition ‘the number of users of the service is equal to or more than “Z”’ of the server 20-6 (e.g., in the case of Z=5000). In this case, the server 20-6 is an example of the first distribution destination server.

In a case where a determination result in this step S26 is No, the distribution unit 15A repeatedly executes the step S26.

### (Step S27)

In a case where the determination result in this step S26 is Yes, the distribution unit 15A carries out, for the first distribution destination server, a changing process for changing a distribution status of the application. Details of the changing process will be described with reference to drawings.

### (Detailed Flow of Changing Process)

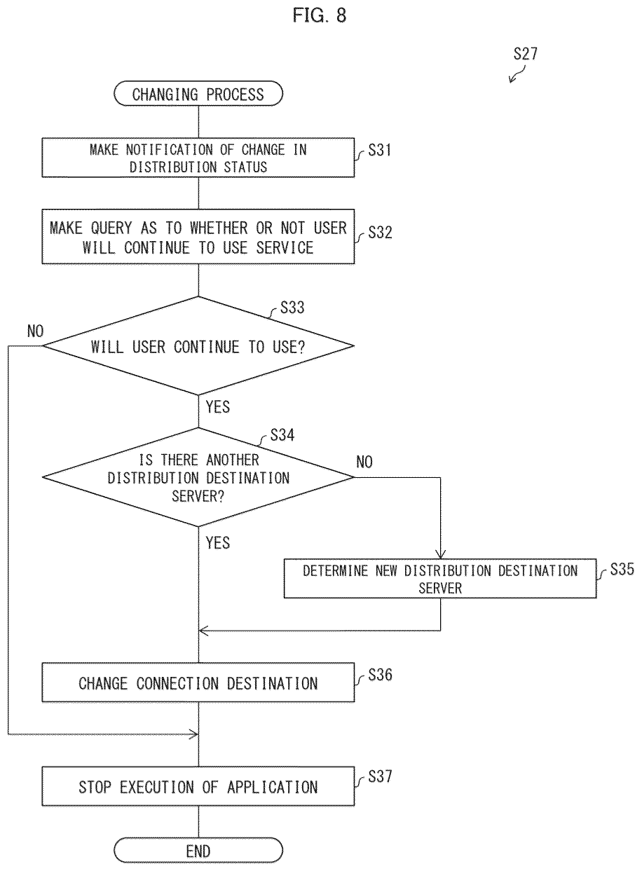

A detailed flow of the changing process in step S27 will be described with reference to FIG. 8. FIG. 8 is a flow chart showing a detailed flow of a changing process. As illustrated in FIG. 8, the changing process includes steps S31 to S37.

### (Step S31)

In step S31, the distribution unit 15A notifies the terminal 30 which is connected to the first distribution destination server of changing the distribution status of the application. Changing the distribution status includes, for example, stopping execution of the application in the first distribution destination server.

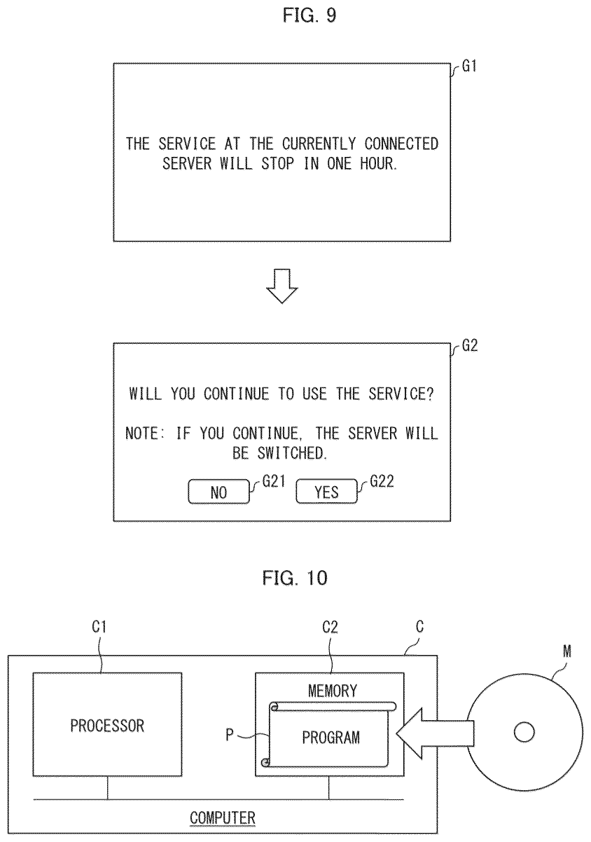

For example, the distribution unit 15A transmits, to the terminal 30-C that is connected to the first distribution destination server (server 20-6), notification information including information that the execution of the application will be stopped. In this example, it is assumed that the terminal 30-C includes a touch panel in which an input apparatus and a display apparatus are integrally formed. The terminal 30-C displays the notification information on the touch panel. The following will describe a specific example of the notification information that is displayed on the touch panel of the terminal 30-C, with reference to FIG. 9. FIG. 9 is a diagram showing a specific example of the notification information that is displayed on the touch panel of the terminal 30-C.

As illustrated in FIG. 9, a screen example G1 is displayed on the touch panel of the terminal 30-C. The screen example G1 includes notification information stating that “The service on the currently connected server will stop in one hour”. In this way, the notification information which the terminal 30-C is notified of may include information indicating a plan to stop execution of the application.

### (Step S32)

In step S32, the distribution unit 15A makes a query to a user of the terminal 30 that is connected to the first distribution destination server, as to whether or not the user will continue to use the service that is provided by the application.

For example, the distribution unit 15A transmits query information that includes the query, to the terminal 30-C that is connected to the first distribution destination server (server 20-6). The terminal 30-C displays the query information on the touch panel. The following will describe a specific example of the query information that is displayed on the touch panel of the terminal 30-C, with reference to FIG. 9. As illustrated in FIG. 9, a screen example G2 is displayed in place of the screen example G1 on the touch panel of the terminal 30-C that has received the query information. The screen example G2 includes the query information that states “Will you continue to use the service? Note: If you continue, the server will be switched.” and operation objects G21 and G22. When an operation to the operation object G21 is received, the terminal 30-C transmits, to the first distribution destination server (server 20-6), information which indicates “No (i.e., the user will not continue to use the service)”. When an operation to the operation object G22 is received, the terminal 30-C transmits, to the first distribution destination server (server 20-6), information which indicates “Yes (i.e., the user will continue to use the service)”.

### (Step S33)

In step S33 of FIG. 8, the distribution unit 15A determines whether or not the user answered that the user would continue to use the service, on the basis of the information received from the terminal 30. In a case where a determination result in this step S33 is No, step S37, which will be described later, is executed.

### (Step S34)

In a case where the determination result in this step S33 is Yes, step S34 is executed. In step S34, the distribution unit 15A determines whether or not there is another server 20 (second distribution destination server) that satisfies the use condition among the one or more distribution destination servers. The second distribution destination server is a server 20 different from the first distribution destination server that no longer satisfies the use condition.

It is assumed here that the number of distribution destination servers determined in step S24 is two or more, and out of the two or more distribution destination servers, at least one distribution destination server that is different from the first distribution destination server still satisfies the use condition. Such a case is, for example, a case where among the distribution destination servers (servers 20-6, 20-7, and 20-8), servers 20-7 and 20-8 that are different from the first distribution destination server (server 20-6) still satisfy the use condition. In this case, the distribution destination servers (servers 20-6 and 20-7) become the second distribution destination server, and the determination result in this step is Yes.

On the other hand, it is assumed that the number of distribution destination servers determined in step S24 is two or more, and all of the distribution destination servers no longer satisfy the use condition. Such a case is, for example, a case where none of the distribution destination servers (servers 20-6, 20-7, and 20-8) satisfies the use condition any longer. In this case, the determination result in this step is No.

Note that in a case where the number of the distribution destination servers determined in step S24 is one, in the first place, there is no second distribution destination server that is different from the first distribution server. Therefore, the determination result in this step S34 is No.

### (Step S35)

In a case where the determination result in step S34 is Yes, step S35 is executed. In step S35, the determination unit 14A determines, from among the candidate servers, a third distribution destination server that satisfies the use condition and that is different from all of the one or more distribution destination servers which have been determined in step S24. The distribution unit 15A also distributes the application to the third distribution destination server thus determined.

For example, it is assumed that among the candidate servers (servers 20-6, 20-7, 20-8, and 20-9), the server 20-9 that previously did not satisfy the use condition presently satisfy the use condition. In this case, the determination unit 14A determines the server 20-9 as the third distribution destination server. Further, the distribution unit 15A newly distributes the application to the server 20-9.

### (Step S36)

In step S36, the distribution unit 15A carries out a process for changing a connection destination of the terminal 30 that is connected to the first distribution destination server.

Specifically, in a case where the determination result in step S34 is Yes, the distribution unit 15A changes the connection destination of the terminal 30 that is connected to the first distribution destination server to the second distribution destination server (another server 20 that satisfies the use condition among the plurality of distribution destination servers). Further, after execution of step S35, the distribution unit 15A changes the connection destination of the terminal 30 that is connected to the first distribution destination server to the third distribution destination server.

Thus, for example, the user of the terminal 30-C that was connected to the first distribution destination server (server 20-6) can be connected to the second distribution destination server (server 20-7 or 20-8) or the third distribution destination server (server 20-9) and continue to use the service.

### (Step S37)

In step S37, the distribution unit 15A stops execution of the application in the first distribution destination server. Further, for example, the distribution unit 15A may delete the application from the first distribution server.

### <Example Advantage of Present Example Embodiment>

As described above, the present example embodiment employs, in addition to the same configuration as in the first example embodiment, a configuration in which the use condition includes a condition related to time for executing an application.

With the configuration, according to the present example embodiment, each server 20 that can be a distribution destination of an application can execute the application during a time which satisfies the use condition of the server 20. On the other hand, during a time which does not satisfy the use condition, each server 20 may not execute the application. As a result, by setting the use condition for each server 20 such that the use condition includes a condition related to a time suitable for execution of an application, the server 20 can be more easily shared.

Further, the present example embodiment employs, in addition to the same configuration as in the first example embodiment, a configuration in which the use condition includes a condition related to an application.

With the configuration, according to the present example embodiment, each server 20 that can be a distribution destination of the application can execute an application that satisfies the use condition of the server 20. On the other hand, each server 20 may not execute the application that does not satisfy the use condition. As a result, by setting the use condition for each server 20 such that the use condition includes a condition related to an application suitable for execution, the server 20 can be more easily shared.

Further, the present example embodiment employs, in addition to the same configuration as in the first example embodiment, a configuration in which the use condition includes a condition related to a requester of a distribution request.

With the configuration, according to the present example embodiment, each server 20 that can be a distribution destination of the application can execute an application that is requested by a requester that satisfies the use condition of the server 20. On the other hand, each server 20 may not execute the application that is requested by a requester that does not satisfy the use condition. As a result, by setting the use condition for each server 20 such that the use condition includes a condition that a requester that requests an application needs to satisfy for allowing for execution of the application, the server 20 can be more easily shared.

Further, the present example embodiment employs, in addition to the same configuration as in the first example embodiment, a configuration in which the use condition includes a condition related to a user(s) of a service by an application.

With the configuration, according to the present example embodiment, each server 20 that can be a distribution destination of an application can execute the application in a case where the use condition of the server 20 which is related to a user(s) of a service by the application is satisfied. On the other hand, the each server 20 may not execute the application in a case where the use condition of the server 20 which is related to the user(s) of the service is not satisfied. As a result, by setting the use condition for each server 20 such that the use condition includes a condition that relates to a user(s) of a service and that needs to be satisfied for allowing for execution of the application, the server 20 can be more easily shared.

Further, the present example embodiment employs, in addition to the same configuration as in the first example embodiment, a configuration in which the use condition includes a condition related to urgency.

With the configuration, according to the present example embodiment, each server 20 that can be a distribution destination of an application can execute the application in a case where the urgency of executing the application satisfies the use condition of the server 20. On the other hand, each server 20 may not execute the application in a case where the urgency does not satisfy the use condition. As a result, by setting the use condition for each server 20 such that the use condition includes a condition that is related to urgency and that needs to be satisfied for allowing for execution of the application, the each server 20 can be more easily shared.

Further, the present example embodiment employs, in addition to the same configuration as in the first example embodiment, a configuration in which for a first distribution destination server that no longer satisfies the use condition among the one or more distribution destination servers to which an application was distributed, a changing process for changing a distribution status of the application is carried out.

With the configuration, according to the present example embodiment, for a server 20 to which the application was distributed, the distribution status of the application can be changed in consideration of a change in state of the use condition of the server 20. As a result, it is possible to more easily share each server 20.

Further, the changing process described above also includes a process for stopping execution of an application in the first destination this distribution server. With configuration, the server 20 (first distribution destination server) to which the application was distributed may not continue to execute the application in a case where the state related to the use condition of the server 20 changes and the use condition is no longer satisfied.

Further, the above-described changing process also includes a process for notifying the terminal 30 which is connected to the first distribution destination server of changing the distribution status of the application. With this configuration, a user who is receiving a service from the server 20 (the first distribution destination server) to which the application was distributed can recognize that the distribution status of the application will be changed.

Further, the above-described changing process also includes a process for making a query to a user of the terminal 30 that is connected to the first distribution destination server, as to whether or not the user will continue to use the service provided by the application. With this configuration, it is possible to carry out a subsequent process in accordance with whether or not the user who is receiving the service from the server 20 (the first distribution destination server) to which the application was distributed will continue to use the service.

In addition, in a case where there are a plurality of distribution destination servers that have been determined, the above-described changing process includes a process for changing the connection destination of the terminal 30 that is connected to the first distribution destination server to a second distribution destination server that satisfies the use condition among the plurality of distribution destination servers. With this configuration, the user who is receiving the service from the server 20 (the first distribution destination server) to which the application was distributed can continue to use the service.

The above-described changing process also includes a process in which the application is distributed to a third distribution destination server that is different from any of the one or more distribution destination servers among the candidate servers and that satisfies the use condition. With the configuration, it is possible to continue to provide the service by the application with use of this third distribution destination server in place of the first distribution destination server.

### Variation 1

The above-described second example embodiment has dealt with an example in which one server 20 (server identifier of one server 20) is associated with one use condition, with reference to FIG. 5. The present invention is not limited thereto, and a plurality of use conditions may be associated with one server 20. In this case, the determination unit 14A may determine a server 20 that satisfies all of the plurality of use conditions as the distribution destination server. Alternatively, the determination unit 14A may determine a server 20 that satisfies any of the plurality of use conditions as the distribution destination server.

### Variation 2

The above-described second example embodiment has dealt with an example in which a plurality of areas are defined so as not to overlap with each other, with reference to FIG. 3. The present invention is not limited thereto, and a part of at least two areas may overlap with each other among the plurality of areas. In this case, in FIG. 5, a plurality of areas may be associated with one server 20. For example, in a case where (i) there is an overlapped portion between the area A and the area B and (ii) the server 20-3 is included in such an overlapped region, the server 20-3 is associated with the area A and the area B.

### Variation 3

In the above-described second example embodiment, the application information may be defined in advance in accordance with an application. In that case, the application information may be stored in the storage unit 120A of the application distribution apparatus 10A. In addition, the distribution request may include the identification information of the application and may not include other application information. In this case, the determination unit 14A acquires, from the storage unit 120A, the application information corresponding to the identification information that is included in the distribution request. Further, the determination unit 14A determines whether or not the distribution request satisfies the use condition by referring to the server information D1, the distribution request, and the application information acquired.

### Variation 4

The above-described second example embodiment has been described on the assumption that the service server 80 provides a service in cooperation with the application which has been distributed to the server 20. The present invention is not limited thereto, and an application that is distributed in response to a distribution request may be an application that provides a service without cooperation with the service server 80.

### Variation 5

The above-described second example embodiment has dealt with an example in which the distribution unit 15A transmits, to the terminal 30 that is connected to the first distribution destination server, notification information which notifies that the distribution status of the application will be changed. The distribution unit 15A is not limited thereto, but may transmit, to the first distribution destination server, the notification information which notifies that the distribution status of the application will be changed. In this case, for example, an administrator of the first distribution destination server can determine: whether to change the distribution status of the application on the basis of the notification information; in a case where the distribution status is determined to be changed, how to change the distribution status; and what process is to be carried out before the distribution status is changed.

### Variation 6

In the above-described second example embodiment, the distribution unit 15A may not necessarily execute all of the steps illustrated in FIG. 8 as the changing process. For example, the distribution unit 15A may carry out the process (S31) for making a notification of change, and may not execute the other steps.

Further, for example, in a case where use is to be continued, the distribution unit 15A may carry out the process (S32, S33, S34, and S36) for changing the connection destination to the second distribution destination server and may not carry out the process (S35 and S36) for changing the connection destination to the third distribution destination server. Alternatively, for example, in a case where use is to be continued, the distribution unit 15A may carry out the process (S32, S33, S35 and S36) for changing the connection destination to the third distribution destination server and may not carry out the process (S34 and S36) for changing the connection destination to the second distribution destination server.

Further, for example, the distribution unit 15A may carry out the process (S37) for stopping execution of the application, without executing any of steps S31 to S36. Alternatively, for example, the distribution unit 15A may carry out the process (S31) for making a notification of change, and then carry out the process (S37) for stopping execution of the application without carrying out any process (S32 to S36) for changing the connection destination.

Further, for example, the distribution unit 15A may carry out the process (S34 to S36) for changing the connection destination without carrying out the process (S32 and S33) for making a query as to whether to continue to use a service. Note that the changing process for changing the distribution status is not limited to the above-described examples.

### Software Implementation Example

Some or all of the functions of apparatuses constituting each of the application distribution apparatuses 10 and 10A may be realized by hardware such as an integrated circuit (IC chip) or may be alternatively realized by software.

In the latter case, the apparatuses constituting each of the application distribution apparatuses 10 and 10A are realized by, for example, a computer that executes instructions of a program that is software realizing the foregoing functions. FIG. 10 illustrates an example of such a computer (hereinafter, referred to as “computer C”). The computer C includes at least one processor C1 and at least one memory C2. In the memory C2, a program P for causing the computer C to operate as the respective apparatuses constituting the application distribution apparatuses 10 and 10A is stored. In the computer C, the foregoing functions of the application distribution apparatuses 10 and 10A can be realized by the processor C1 reading and executing the program P stored in the memory C2.

Examples of the processor C1 encompass a central processing unit (CPU), a graphic processing unit (GPU), a digital signal processor (DSP), a micro processing unit (MPU), a floating point number processing unit (FPU), a physics processing unit (PPU), a microcontroller or a combination thereof. The memory C2 may be, for example, a flash memory, a hard disk drive (HDD), a solid state drive (SSD), or a combination thereof.

Note that the computer C may further include a random access memory (RAM) in which the program P is loaded when executed and/or in which various kinds of data are temporarily stored. The computer C may further include a communication interface for transmitting and receiving data to and from another apparatus. The computer C may further include an input/output interface for connecting the computer C to an input/output apparatus(es) such as a keyboard, a mouse, a display, and/or a printer.

The program P can also be stored in a non-transitory tangible storage medium M from which the computer C can read the program P. Such a storage medium M may be, for example, a tape, a disk, a card, a semiconductor memory, a programmable logic circuit, or the like. The computer C can acquire the program P via the storage medium M. The program P can also be transmitted via a transmission medium. The transmission medium may be, for example, a communication network, a broadcast wave, or the like. The computer C can acquire the program P also via such a transmission medium.

### Additional Remark 1

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### Additional Remark 2

The whole or part of the example embodiments disclosed above can also be described as below. Note, however, that the present invention is not limited to the following example aspects.

### (Supplementary Note 1)

An application distribution apparatus including:
a management means that manages, for each of a plurality of servers, a location and a use condition of the server;
an acquisition means that acquires a distribution request for an application, the distribution request including information pertaining to a desired execution area;
a selection means that selects, as candidate servers, servers included in the desired execution area from among the plurality of servers;
a determination means that determines one or more distribution destination servers that satisfy the use condition from among the candidate servers; and
a distribution means that distributes the application to the one or more distribution destination servers.

### (Supplementary Note 2)

The application distribution apparatus according to supplementary note 1, wherein the use condition includes a condition related to time for executing the application.

### (Supplementary Note 3)

The application distribution apparatus according to supplementary note 1 or 2, wherein the use condition includes a condition related to the application.

### (Supplementary Note 4)

The application distribution apparatus according to any one of supplementary notes 1 to 3, wherein the use condition includes a condition related to a requester that made the distribution request.

### (Supplementary Note 5)

The application distribution apparatus according to any one of supplementary notes 1 to 4, wherein the use condition includes a condition related to a user of a service that is provided by the application.

### (Supplementary Note 6)

The application distribution apparatus according to any one of supplementary notes 1 to 5, wherein the use condition includes a condition related to urgency.

### (Supplementary Note 7)

The application distribution apparatus according to any one of supplementary notes 1 to 6, wherein the distribution means carries out a changing process for changing a distribution status of the application, for a first distribution destination server that no longer satisfies the use condition among the one or more distribution destination servers to which the application was distributed.

### (Supplementary Note 8)

The application distribution apparatus according to supplementary note 7, wherein the changing process includes a process for stopping execution of the application by the first distribution destination server.

### (Supplementary Note 9)

The application distribution apparatus according to supplementary note 7 or 8, wherein the changing process includes a process for notifying the first distribution destination server or a terminal which is connected to the first distribution destination server of changing the distribution status of the application.

### (Supplementary Note 10)

The application distribution apparatus according to any one of supplementary notes 7 to 9, wherein the changing process includes a process for making a query to a user of a terminal that is connected to the first distribution destination server, as to whether or not the user is going to continue to use a service provided by the application.

### (Supplementary Note 11)

An application distribution apparatus according to any one of supplementary notes 7 to 10, wherein
in a case where the determination means has determined a plurality of distribution destination servers,
the changing process includes a process for changing, to a second distribution destination server that satisfies the use condition among the plurality of distribution destination servers, a connection destination of a terminal that is connected to the first distribution destination server.

### (Supplementary Note 12)

An application distribution apparatus according to any one of supplementary notes 7 to 10, wherein the changing process includes a process for distributing the application to a third distribution destination server among the candidate servers, the third distribution destination server differing from all of the one or more distribution destination servers and satisfying the use condition.

### (Supplementary Note 13)

An application distribution method including:
managing, for each of a plurality of servers, a location and a use condition of the server;
acquiring a distribution request for an application, the distribution request including information pertaining to a desired execution area;
selecting, as candidate servers, servers included in the desired execution area from among the plurality of servers;
determining one or more distribution destination servers that satisfy the use condition from among the candidate servers; and
distributing the application to the one or more distribution destination servers.

### (Supplementary Note 14)

A program for causing a computer to function as an application distribution apparatus, the program causing the computer to function as:
a management means that manages, for each of a plurality of servers, a location and a use condition of the server;
an acquisition means that acquires a distribution request for an application, the distribution request including information pertaining to a desired execution area;
a selection means that selects, as candidate servers, servers included in the desired execution area from among the plurality of servers;
a determination means that determines one or more distribution destination servers that satisfy the use condition from among the candidate servers; and
a distribution means that distributes the application to the one or more distribution destination servers.

### Additional remark 3

Some of or all of the foregoing example embodiments can further be expressed as below.

An application distribution apparatus including at least one processor, the processer being configured to carry out: a management process for managing, for each of a plurality of servers, a location and a use condition of the server; an acquisition process for acquiring a distribution request for an application, the distribution request including information pertaining to a desired execution area; a selection process for selecting, as candidate servers, servers included in the desired execution area from among the plurality of servers; a determination process for determining one or more distribution destination servers that satisfy the use condition from among the candidate servers; and a distribution process for distributing the application to the one or more distribution destination servers.

Note that this application distribution apparatus can further include a memory. The memory can store a program for causing the processor to carry out the management process, the acquisition process, the selection process, the determination process, and the distribution process. In addition, the program may be stored in a computer-readable non-transitory tangible storage medium.

### REFERENCE SIGNS LIST

1A application distribution system
10, 10A application distribution apparatus
11, 11A management unit
12, 12A acquisition unit
13, 13A selection unit
14, 14A determination unit
15, 15A distribution unit
20, 20-1 to 20-9 server
30, 30-A, 30-B, 30-C terminal
80 service server
110A control unit
120A storage unit
130A communication unit
C1 processor
C2 memory

What is claimed is:

1. An application distribution apparatus comprising at least one processor,
the at least one processer carrying out:
a management process for managing, for each of a plurality of servers, a location and a use condition of the server;
an acquisition process for acquiring a distribution request for an application, the distribution request including information pertaining to a desired execution area;
a selection process for selecting, as candidate servers, servers included in the desired execution area from among the plurality of servers;
a determination process for determining one or more distribution destination servers that satisfy the use condition from among the candidate servers; and
a distribution process for distributing means that distributes the application to the one or more distribution destination servers.

2. The application distribution apparatus according to claim 1, wherein the use condition includes a condition related to time for executing the application.

3. The application distribution apparatus according to claim 1, wherein the use condition includes a condition related to the application.

4. The application distribution apparatus according to claim 1, wherein the use condition includes a condition related to a requester that made the distribution request.

5. The application distribution apparatus according to claim 1 4, wherein the use condition includes a condition related to a user of a service that is provided by the application.

6. The application distribution apparatus according to claim 1, wherein the use condition includes a condition related to urgency.

7. The application distribution apparatus according to claim 1, wherein in the distribution process, the at least one processor carries out a changing process for changing a distribution status of the application, for a first distribution destination server that no longer satisfies the use condition among the one or more distribution destination servers to which the application was distributed.

8. The application distribution apparatus according to claim 7, wherein the changing process includes a process for stopping execution of the application by the first distribution destination server.

9. The application distribution apparatus according to claim 7, wherein the changing process includes a process for notifying the first distribution destination server or a terminal which is connected to the first distribution destination server of changing the distribution status of the application.

10. The application distribution apparatus according to claim 7, wherein the changing process includes a process for making a query to a user of a terminal that is connected to the first distribution destination server as to whether or not the user is going to continue to use a service provided by the application.

11. The application distribution apparatus according to claim 7, wherein
in a case where in the determination process, the at least one processor has determined a plurality of distribution destination servers,
the changing process includes a process for changing, to a second distribution destination server that satisfies the use condition among the plurality of distribution destination servers, a connection destination of a terminal that is connected to the first distribution destination server.

12. The application distribution apparatus according to claim 7, wherein the changing process includes a process for distributing the application to a third distribution destination server among the candidate servers, the third distribution destination server differing from all of the one or more distribution destination servers and satisfying the use condition.

13. An application distribution method comprising:
managing, for each of a plurality of servers, a location and a use condition of the server;
acquiring a distribution request for an application, the distribution request including information pertaining to a desired execution area;
selecting, as candidate servers, servers included in the desired execution area from among the plurality of servers;
determining one or more distribution destination servers that satisfy the use condition from among the candidate servers; and
distributing the application to the one or more distribution destination servers.

14. A non-transitory storage medium storing a program for causing a computer to function as an application distribution apparatus, the program causing the computer to carry out:
a management process for managing, for each of a plurality of servers, a location and a use condition of the server;
an acquisition process for acquiring a distribution request for an application, the distribution request including information pertaining to a desired execution area;
a selection process for selecting, as candidate servers, servers included in the desired execution area from among the plurality of servers;
a determination process for determining one or more distribution destination servers that satisfy the use condition from among the candidate servers; and
a distribution process for distributing the application to the one or more distribution destination servers.
